(19) United States
(12) Patent Application Publication
(10) Pub. No.: US 2014/0188018 A1
(43) Pub. Date: Jul. 3, 2014

(54) MASSAGE CUSHION ASSEMBLIES

(71) Applicant: Tempur-Pedic Management, Lexington, KY (US)

(72) Inventors: Norman L. Vaughn, Kingsport, TN (US); Christopher L. Glover, Kingsport, TN (US); David Mandel, Washington, DC (US)

(21) Appl. No.: 14/110,985

(22) PCT Filed: Dec. 28, 2012
(86) PCT No.: PCT/US12/71991

§ 371 Date: Oct. 10, 2013

(51) Int. Cl. A61H 15/00

(52) U.S. Cl. CPC A61H 15/0078
USPC 601/90

(57) ABSTRACT

A massage cushion assembly for providing a massage to a user resting on the massage cushion assembly is provided. The massage cushion assembly includes a body supporting portion having a first surface and a second surface opposite the first surface, a base portion defining one or more slots extending longitudinally through the base portion, and a massage unit including one or more massage members. Each of the massage members is movable along a length of a particular slot and between a raised position and a lowered position. Each massage member is further positioned in a particular slot such that a head portion of the massage member extends out of the slot and presses against the second surface of the body supporting portion when the massage member is in the raised position.

### TECHNICAL FIELD

The present invention relates to massage cushion assemblies for providing a massage to a user resting on the massage cushion assembly. In particular, the present invention relates to massage cushion assemblies, such, as massage bed assemblies, that make use of one or more massage members moveable along slots in a base portion of the massage cushion assembly and moveable between a raised and lowered position to thereby provide a massage to a user resting on the massage cushion assembly.

### BACKGROUND

An aspect of successful rest and relaxation is individual comfort. However, neck or back pain resulting from automobile accidents, falls, or en day-to-day activities, such as sitting at a computer or excessive standing, can have significant negative impacts on the ability to rest and relax, and on overall mental and physical health. Research has indicated that neck or back pain can often be reduced or eliminated by applying pressure along an individual's neck or back and, more specifically, by applying pressure to certain pressure points that are located on the neck or back of an individual. In this regard, massage techniques, such as Shiatsu massage techniques, have been shown to relieve neck or back pain by manipulating the pressure points on the neck or back of an individual and by releasing muscular tension that causes or otherwise leads to further neck or back pain. Furthermore, the use of massage techniques have recently been linked to alleviating symptoms in disorders ranging from depression and anxiety to nausea, headaches, arthritis, and cramps. Accordingly, a cushion assembly that improves individual comfort and massages the body of an individual, or portions thereof, resting on the support cushion would be both highly desirable and beneficial.

### SUMMARY

The present invention relates to massage cushion assemblies for providing a massage to a user resting on the massage cushion assembly. In particular, the present invention relates to massage cushion assemblies, such as massage bed assemblies, that make use of one or more massage members moveable along slots in a base portion of the massage cushion assembly and moveable between a raised and lowered position to thereby provide a massage to a user resting on the massage cushion assembly. Thus, the massage cushion assemblies of the present invention allow a user to increase their level of comfort including their ability to rest and relax, by incorporating a massage device into a cushion on which a user can rest his or her body or a portion thereof.

In one exemplary embodiment of the present invention, a massage cushion assembly is provided in the form of a massage bed assembly that includes a body supporting portion having a first surface and a second surface opposite the first surface. The massage bed assembly also includes a base portion that defines one or more slots extending longitudinally through the base portion, and that is separated from the body supporting portion by a protective layer positioned between the second surface of the body supporting portion and the base portion. The massage bed assembly also includes a massage unit having one or more massage members. Each of the massage members included, in the massage unit is movable along a length of a particular slot and is further moveable between a raised position and a lowered position. Additionally, each of the massage members is positioned in a particular slot, such that a head portion of the massage member extends out of the slot, contacts the protective layer, and presses against the second surface of the body supporting portion when the massage member is in the raised position, but yet is housed within the slot defiled by the base portion when the massage member is in the lowered position and is not pressing against the body supporting portion.

The body supporting portion of the massage bed assembly is generally comprised of a flexible foam for suitably distributing pressure from a user's body or portion thereof across the body supporting portion. In some embodiments, the flexible foam is a visco-elastic foam that has a desired density and hardness, and allows pressure to be absorbed uniformly and distributed evenly across the body supporting portion of the massage bed assembly. In this regard, in certain embodiments, the body supporting portion is further covered by a comfort portion or layer that is positioned atop the body supporting portion to provide a level of comfort to a body of a user or a portion thereof that is resting on the mattress assembly. Such a comfort support portion, in certain embodiments, is also comprised of a visco-elastic foam or other foam, but typically has a density less than that of the body supporting portion of the mattress assembly so as to provide a softer surface on which to rest, and so as to provide a sufficiently soft barrier between the body of a user and the massage members of the massage bed assembly.

With respect to the massage units of the massage bed assembly, each massage unit generally includes a guide track and a motor for moving the one or more massage members along the length of the respective slots in a manner that is directed by the guide track. In certain embodiments, the guide track includes a serpentine channel, such that the massage members move in a wavelike pattern along the length of the slots upon activating the motor, and thereby provides a massage where the massage members move in a wavelike motion against the body of a user.

Each massage member of the present invention also generally includes a rod attached to the head portion of the massage member at one end of the rod, with the other end of the rod received in a cylinder and movable with respect to the cylinder. In certain embodiments, the head portion attached to the rod is comprised of a wheel such that, when the massage member is in a raised position, the wheel rolls along and pushes against the second surface of the body supporting portion to thereby provide a massage to the body of a user, or a portion thereof, that is resting on the massage bed assembly. In other embodiments, the head portion of each massage member is comprised of a spherical caster that is configured to roll along the second surface of the body supporting portion when the massage member is in the raised position. In such embodiments, to provide further massaging capabilities to the spherical caster, the swivel caster is mounted to swivel relative to the rod, such that, as the massage member including the spherical caster moves along a particular non-linear channel of the guide track (e.g., a serpentine channel), the spherical caster mover in a manner that allows the caster to roll easily against the body supporting portion and to provide a user resting on the massage bed assembly with a smooth and continuous massage.

Regardless of the configuration of the head portion of the massage members, the massage bed assembly further includes a foundation that is positioned below the base layer and that is configured to provide support to the base layer and the body supporting portion. In this regard, the massage unit included in the massage bed assembly is typically secured to the foundation such that the massage members move relative to the foundation. Moreover, in certain embodiments, the foundation is adjustable such that a user can place the massage bed assembly into one or more ergonomic positions suitable for receiving a massage and improving individual comfort.

Further features and advantages of the present invention will become evident to those of ordinary skill in the art after a study of the description, figures, and non-limiting examples in this document.

### BRIEF DESCRIPTION OF THE DRAWINGS

FIG. 1 is a perspective view of an exemplary massage cushion assembly, in the form of a massage bed assembly, made in accordance with the present invention, and with a portion of the massage bed assembly removed to show a massage unit positioned in the massage bed assembly;

FIG. 2 is a partial cross-sectional view of the exemplary massage bed assembly of FIG. 1;

FIGS. 3A-3C are schematic representations showing an exemplary massage member of a massage cushion assembly made in accordance with the present invention moving between a lowered and raised position;

FIG. 4 is a perspective view of an exemplary massage unit made in accordance with the present invention;

FIG. 5 is a perspective view of another exemplary massage cushion assembly, in the form of a chair cushion assembly, made in accordance with the present invention, and with a portion of the chair cushion removed to show a massage unit positioned in the chair cushion assembly; and

FIG. 6 is a perspective view of an exemplary remote control for controlling the massage units of a massage cushion assembly made in accordance with the present invention.

### DESCRIPTION OF EXEMPLARY EMBODIMENTS

The present invention relates to massage cushion assemblies for providing a massage to a user resting on the massage cushion assembly. In particular, the present invention relates to massage cushion assemblies, such as massage bed assemblies, that include one or more massage members moveable along slots in a base portion of the massage cushion assembly and moveable between a raised and lowered position. The massage cushion assemblies of the present invention allow a user resting on the massage cushion assembly to obtain a massage by raising and moving the massage members without also requiring the use of vibrating massage elements or other similar devices to massage the body of the user, or a portion thereof. Thus, the massage cushion assemblies of the present invention allow a user resting on the massage cushion assemblies to improve their individual comfort and obtain a massage by applying pressure to their body or a portion thereof, and more specifically, by applying pressure to pressure points on the body of a user in a manner that avoids the use of conventional massage systems that make use of vibrating massage elements or other similar devices.

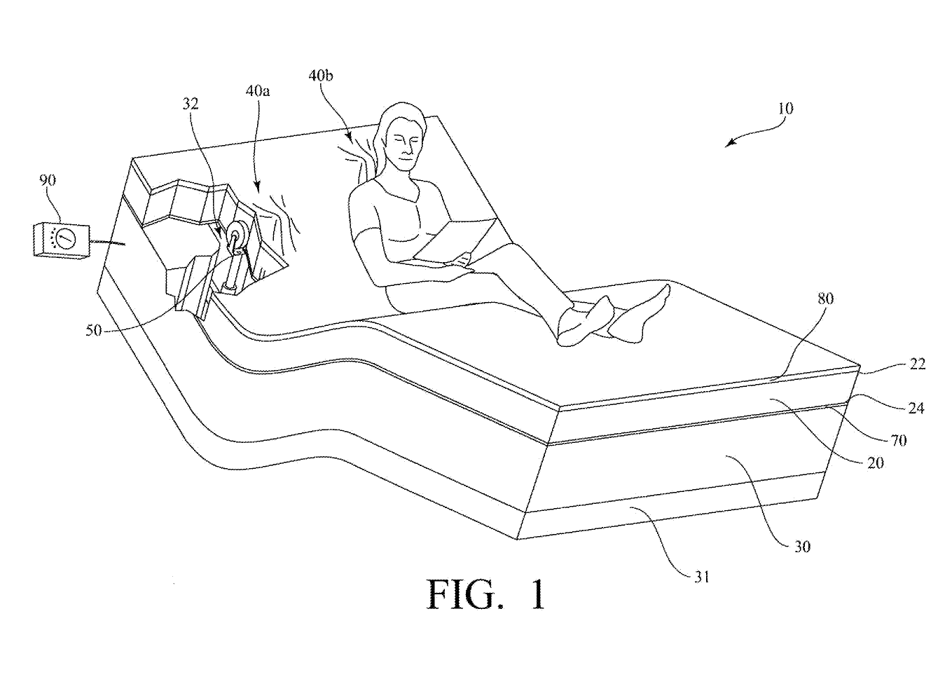

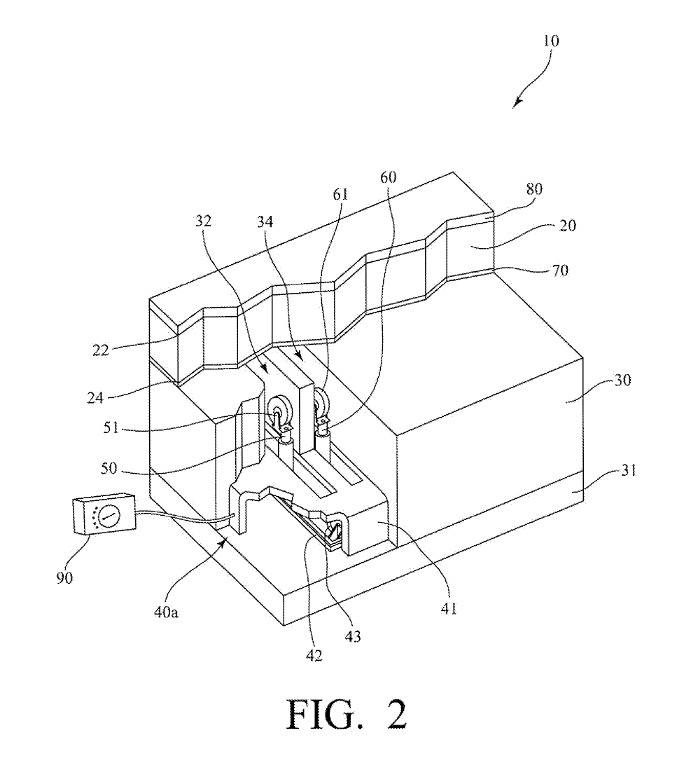

Referring first to FIGS. 1-2, in one exemplary embodiment of the present invention, a massage cushion assembly is provided in the form of a massage bed assembly 10. The massage bed assembly 10 includes a body supporting portion 20 having a first surface 22, which is generally an upper surface of the body supporting portion 20, and a second surface 24, which is generally the lower surface of the body supporting portion 20 and is opposite the first surface 22. The massage bed assembly 10 also includes a base portion 30 that is separated from the body supporting portion 20 by a protective layer 70. The base portion 30 defines one or more slots 32, 34 in the base portion 30 that extend longitudinally through the base portion 30. The massage bed assembly 10 further includes a first massage unit 40a and a second massage unit 40b that are positioned in the massage bed assembly 10 and are configured to provide a massage to the body of a user, or a portion thereof, resting on the massage bed assembly 10.

The body supporting portion 20 of the massage bed assembly 10 is generally comprised of a continuous layer of flexible foam for suitably distributing pressure from a user's body or portion thereof across the body supporting portion 20, while the base portion 30 of the massage bed assembly 10 is generally comprised of a flexible foam having a sufficient density and hardness for supporting the body supporting portion 20. Such flexible foams include, but are not limited to, latex foam, reticulated or non-reticulated visco-elastic foam. (sometimes referred to as memory foam or low-resilience foam), reticulated or non-reticulated non-visco-elastic foam, high-resilience polyurethane foam, expanded polymer foams (e.g., expanded ethylene vinyl acetate, polypropylene, polystyrene, or polyethylene), and the like. In the embodiment shown in FIGS. 1-2, the base portion 30 is comprised of a high-resilience foam, while the body supporting portion 20 is comprised of a visco-elastic foam that has a low resilience as well as a sufficient density and hardness, which allows pressure to be absorbed uniformly and distributed evenly across the body supporting portion 20 of the massage bed assembly 10. Generally, such visco-elastic foams have a hardness of at least about 10 N to no greater than about 80 N, as measured by exerting pressure from a plate against a sample of the material to a compression of at least 40% of an original thickness of the material at approximately room temperature (i.e., 21° C. to 23° C.), where the 40% compression is held for a set period of time as established by the International Organization of Standardization (ISO) 2439 hardness measuring standard. In some embodiments, the visco-elastic foam has a hardness of about 10 N, about 20 N, about 30 N, about 40 N, about 50 N, about 60 N, about 70 N, or about 80 N to provide a desired degree of comfort and body-conforming qualities.

The visco-elastic foam described herein for use in the massage bed assembly 10 can also have a density that assists in providing a desired degree of comfort and body-conforming qualities, as well as an increased degree of material durability. In some embodiments, the density of the visco-elastic foam used in the body supporting portion 20 has a density of no less than about 30 kg/m³ to no greater than about 150 kg/m³. In some embodiments, the density of the visco-elastic foam used in the body supporting portion 20 of the massage bed assembly 10 is about 30 kg/m³, about 40 kg/m³, about 50 kg/m³, about 60 kg/m³, about 70 kg/m³, about 80 kg/m³, about 90 kg/m³, about 100 kg/m³, about 110 kg/m³, about 120 kg/m³, about 130 kg/m³, about 140 kg/m³, or about 150 kg/m³. Of course, the selection of a visco-elastic foam having a particular density will affect other characteristics of the foam, including its hardness, the manner in which the foam responds to pressure, and the overall feel of the foam, but it is appreciated that a visco-elastic foam having a desired density and hardness can readily be selected for a particular application or massage bed assembly as desired. Additionally, it is appreciated that the body supporting portions of the massage bed assemblies need not be comprised of a continuous layer of flexible foam at all, but can also take the form of more traditional mattresses, including spring-based mattresses, without departing from the spirit and scope of the subject matter described herein.

Referring still to FIGS. 1-2, the body supporting portion 20 is further covered by a comfort portion or layer 80 that is positioned atop the first surface 22 of the body supporting portion 20 and provides a level of comfort to a body of a user or a portion of thereof that is resting on the massage bed assembly 10. The comfort layer 80 can also be comprised of a visco-elastic foam. However, the comfort layer 80 typically has a density, hardness, or both that is less than that of the body supporting portion 20 of the massage bed assembly 10, such that the comfort layer 80 provides a softer surface on which to rest the body of a user or a portion thereof, while also providing a sufficiently soft barrier between the body of a user and the massage members 50, 60 of the massage bed assembly 10, as described in further detail below. For example, in certain embodiments, the massage bed assembly 10 includes a body supporting portion 20 that is comprised of visco-elastic foam with a density of about 80 kg/m³ and a hardness of about 13 N, while the comfort layer is comprised of a visco-elastic foam with a density of about 35 kg/m³ and a hardness of about 10 N.

Regardless of the particular densities or materials used, the base portion 30, the body supporting portion 20, the protective layer 70, and the comfort layer 80 are generally secured to one another to prevent the various layers from moving relative to one another during use. Various means of securing one layer of material to another can be used in this regard, including tape, hook and loop fasteners, conventional fasteners, stitches, and the like. In one particular embodiment, the base portion 30, the body supporting portion 20, the protective layer 70, and the comfort layer 80 are bonded together by an adhesive or cohesive bonding material to create a substantially continuous assembly where the base portion 30, the body supporting portion 20, the protective layers, and the comfort layer 80 are fully adhered to one another. Such adhesive bonding materials include, for example, environmentally-friendly, water based adhesives, like SABA AQUABOND RSD, a two-component water-based adhesive product produced by SABA DINXPERLO BV, B-7090 AA, Dinxperlo, Belgium.

With further regard to the body supporting portions of the mattress assemblies of the present invention, as indicated above, the body supporting portions are generally comprised of one or more layers of visco-elastic foam having a density and hardness suitable for distributing pressure from a user's body, or portion thereof. However, it is additionally contemplated that an exemplary body supporting portion can be further comprised of one or more different or additional layers having various densities and hardnesses. For instance, it is contemplated that a layer of high-resilience polyurethane foam can be secured to the second surface of a layer of low-resilience visco-elastic foam used in a body supporting portion. Such multi-layered body supporting portions are described, for example, in U.S. Pat. Nos. 7,469,437; 7,507,468; 8,025,964; and 8,034,445, as well as in U.S. Patent Application Publication No. 2011/0252562, each of which is incorporated herein by this reference.

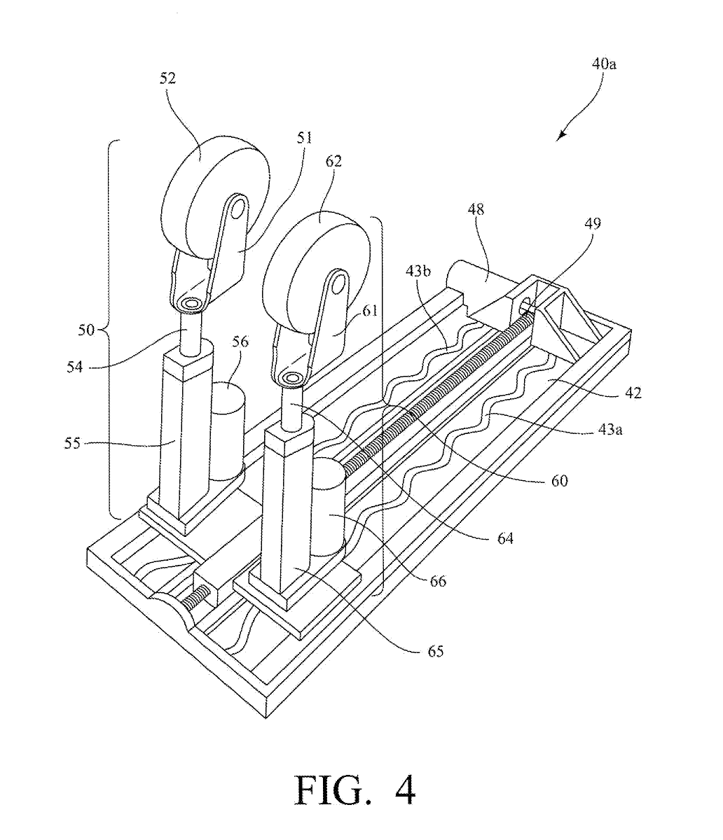

Turning now to the massage units included in the massage bed assemblies of the present invention, and referring now to FIGS. 2 and 4, the massage unit 40a includes two massage members 50, 60 positioned in the slots 32, 34 defined by the base portion 30. By positioning the massage members 50, 60 in the slots 32, 34, the head portions 51, 61 of the massage members 50, 60 can extend out of the slots 32, 34, contact the protective layer 70, and press against the second surface 24 of the body supporting portion 20 when the massage members 50, 60 are in the raised position, as described in further detail below. However, by positioning the massage members 50, 60 in the slots 32, 34, the head portions 51, 61 of the massage members 50, 60 are also configured to be housed within the slots 32, 34 defined by the base portion 30 when the massage members 50, 60 are in a lowered position and are not contacting the protective layer 70 and pressing against the body supporting portion 20 of the massage bed assembly 10, as perhaps best shown in FIG. 2.

Referring still to FIGS. 2 and 4, to allow the massage members 50, 60 to move along the slots 32, 34, the massage unit 40a further includes a guide track 42 secured to a foundation 31 of the massage bed assembly 10. Attached to the guide track 42 is a motor 48 that is operably connected to a screw drive 49. The screw drive 49 is further operably connected to the massage members 50, 60 such that, upon activating the motor 48, the motor 48 turns the screw drive 49 and causes the massage members 50, 60 to move along the length of the guide track 42 of the massage unit 40a. In this regard, to prevent the motor 48, the screw drive 49, and other movable components of the massage unit 40a from becoming obstructed by the materials comprising the base portion 30 and to prevent the base portion 30 from undergoing unnecessary wear and tear as a result of coming into unnecessary contact with the various components, the massage unit 40a further includes a housing 41 that isolates the guide track 42, the motor 48, and the screw drive 49 from the base portion 30 of the massage bed assembly 10. Of course, various other devices for moving the massage members 50, 60 along the slots 32, 34 of the base portion 30, including motor and gear assemblies, and the like can also be incorporated into a massage bed assembly of the present invention and positioned to suitably isolate the moving components from the base portion 30 without departing from the spirit and scope of the subject matter described herein.

Referring now to FIG. 4, in this exemplary embodiments, the guide track 42 also includes a pair of serpentine channels 43a, 43b that direct the movement of the massage members 50, 60 as the massage members 50, 60 travel along the guide track 42 and along the length of the respective slots 32, 34 defined by the base portion 30. By including the serpentine channels 43a, 43b in the guide track 42, upon activating the motor 48 and the screw drive 49, the massage members 50, 60 thus move in a wavelike pattern along the length of the slots 32, 34, and thereby provide a massage to a user where the massage members 50, 60 move in a wavelike motion against the body of the user.

To provide massage members 50, 60 that are easily moveable between a raised and lowered position, while also being movable longitudinally, the massage members 50, 60 each include a rod 54, 64 attached to a head portion 51, 61 at one end of each rod 54, 64, with the other end of each rod 54, 64 received in and moveable with respect to a cylinder 55, 65. Various mechanical means known to those of ordinary skill in the art can thus be used to move the rods 54, 64 with respect to the cylinders 55, 65. As one example of such a mechanical means, in the massage unit 40a shown in FIG. 4, the rods 54, 64 and the cylinders 55, 65 of the massage members 50, 60 are operably connected to linear actuators 56, 66 that are configured to move the rods 54, 64 and, consequently, the head portions 51, 61 attached to the rods 54, 64 between a lowered position and a raised position. The rods 54, 64 may also be quickly raised and lowered to create a pulsating massage. This pulsation may occur when the massage members 50, 60 are fixed in position or traveling along the slots 32, 34.

Referring again to both FIGS. 2 and 4, the head portions 51, 61 of the massage members 50, 60 each include a wheel 52, 62. Each wheel 52, 62 of the massage members 50. 60 is configured to rotate relative to the head portions 51, 61 and is further configured to swivel relative to a vertical axis of rotation defined by each rod 54, 64. As such, when the massage members 50, 60 are in the raised position, the wheels 52, 62 are not only configured to smoothly roll against the protective layer 70, but are also configured to be capable of changing their direction of movement as the massage members 50, 60 move along the serpentine channels 43a, 43b included in the guide track 42.

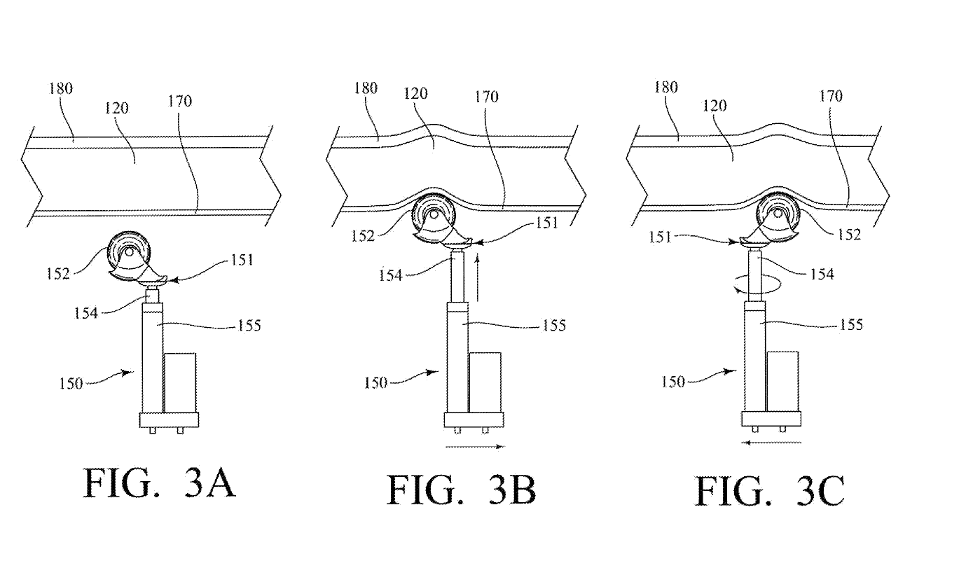

As a refinement, and referring now to FIGS. 3A-3C, an alternate head portion 151 of a massage member 150 is provided that includes a spherical caster 152 attached to a rod 154 and the rod 154 is then received and moveable with respect to a cylinder 155. Like the wheels 52, 62 included on the head portions 51, 61 shown in FIGS. 2-4, the spherical caster 152 is configured to rotate relative to the head portion 151 and is further configured to swivel relative to a vertical axis of rotation defined by the rod 154. In this regard, when the spherical caster 152 is raised from a lowered position, shown in FIG. 3A, to a raised position, the spherical caster 152 is configured to smoothly roll against and the protective layer 170 and is configured to change its direction of movement as the massage member 150 moves in a longitudinal direction, such as along a non-linear channel (e.g., a serpentine channel). The spherical caster 152 is also configured such that it can more readily swivel over a complete 360° range of motion, as shown in FIG. 3C, to allow the spherical caster 152 to more easily roll against the protective layer 170 the body supporting portion 120, and the comfort layer 180 and to provide a user resting on an exemplary massage bed assembly with a smoother and more continuous massage.

Regardless of the particular configuration of the head portions of the massage members included in the massage bed assemblies of the present invention, and referring again to FIGS. 1-2, the massage bed assembly 10 further comprises a controller 90 operably connected to the massage units 40a, 40b for controlling the massage units 40a, 40b. By including the controller 90 in the massage bed assembly 10, both the height of the massage members 50, 60 can be controlled as well as the rate at which the massage members 50, 60 move along the length of their respective slots 32, 34 defined by the base portion 30 of the massage bed assembly 10. The controller 90 may also control the pulsating of the massage members 50, 60. Additionally, by including the controller 90 in the massage bed assembly 10, the controller 90 can be configured such that the massage unit 40a on one side of the massage bed assembly 10 can be controlled independently of the massage unit 40b on an opposite side of the massage bed assembly. For example, the controller 90 can be configured such that massage unit 40a is positioned to and is providing a massage to the lumbar region of a first user resting on one side of the massage bed assembly 10, while the massage unit 40b is positioned to and is providing a massage to the neck region of a second user resting on the opposite side of the massage bed assembly 10. Such control over the massage units 40a, 40b are, in some embodiments, directly inputted or adjusted at the controller 90 itself or, in other embodiments, are transmitted to the controller 90 from a remote control 500 that includes buttons 510 for controlling the massage unit 40a located on one side of the massage bed assembly and buttons 520 for controlling the massage unit 40b located on the opposite side of the massage bed assembly, as shown in FIG. 6.

As indicated above, the massage bed assembly 10 further includes the protective layer 70 that is positioned the second surface 24 of the body supporting portion 20 and the base portion 30. The protective layer 70 is generally comprised of a durable material and is designed to protect the body supporting portion against unnecessary wear and tear as a result of the movement of the head portions 51, 61. Additionally, and as also indicated above, the massage assembly 10 includes the foundation 31, which is positioned below the base portion 30. The foundation 31 is not only configured to provide support to the base portion 30 and the body supporting portion 20, but is also configured to increase the comfort and convenience of a user of the massage bed assembly 10. In particular, in the massage bed assembly 10, the foundation is adjustable to allow a user to place the massage bed assembly 10 into one or more ergonomic positions suitable for receiving a massage and improving individual comfort, as shown in FIG. 1.

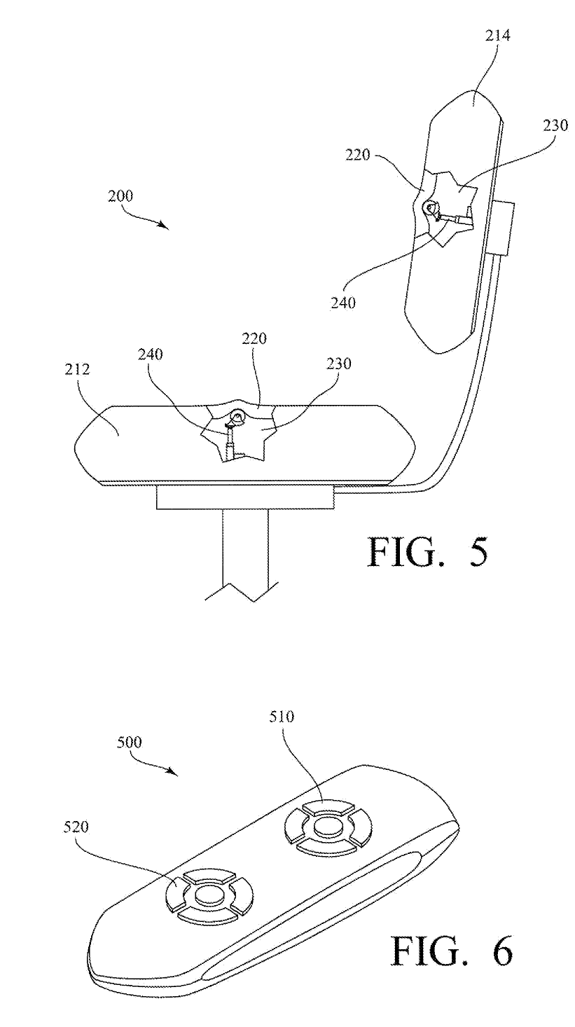

As a further refinement to the present invention, although the massage cushion assemblies shown in FIGS. 1-3 are in the form of a massage bed assemblies, it is contemplated that the features of the massage cushion assemblies are equally applicable to seat cushions, overlays, massage chairs, massage day beds, and the like. For example, as shown in FIG. 5, massage cushion assemblies made in accordance with the present invention can be incorporated into the seat 212 and the back 214 of a desk chair 200, where both the seat 212 and the back 214 of the desk chair 200 include a body supporting portion 220, a base portion 230, and a massage unit 240 to suitably provide a massage to multiple portions of a body of a user sitting on the desk chair 200.

One of ordinary skill in the art will recognize that additional embodiments are possible without departing from the teachings of the present invention or the scope of the claims which follow. This detailed description, and particularly the specific details of the exemplary embodiments disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A massage cushion assembly, comprising:
a body supporting portion having a first surface and a second surface opposite the first surface;
a base portion defining one or more slots extending longitudinally through the base portion; and
a massage unit including one or more massage members, each of the one or more massage members being movable along a length of a particular slot and between a raised position and a lowered position, and each of the one or more massage members being positioned in a particular slot such that a head portion of the massage member extends out of the slot and presses against the second surface of the body supporting portion when the massage member is in the raised position.

2. The massage cushion assembly of claim 1, wherein the head portion of each massage member is housed within a particular slot defined by the base portion when the massage member is in the lowered position.

3. The massage cushion assembly of claim 1, wherein the massage unit further comprises a guide track and a motor for moving the one or more massage members along the length of the respective slots as directed by the guide track.

4. The massage cushion assembly of claim 3, wherein the guide track comprises a serpentine channel such that the massage members move in a wavelike pattern along the length of the slots upon activating the motor.

5. The massage cushion assembly of claim 1, wherein each massage member includes a rod attached to the head portion at one end of the rod, with another end of the rod received in and movable with respect to a cylinder.

6. The massage cushion assembly of claim 5, wherein the head portion of each massage member comprises a wheel configured to roll along the second surface of the body supporting portion when each massage member is in the raised position.

7. The massage cushion assembly of claim 5, wherein the head portion of each massage member comprises a spherical caster configured to roll along the second surface of the body supporting portion when each massage member is in the raised position.

8. The massage cushion assembly of claim 7, wherein the spherical caster is mounted to swivel relative to the rod.

9. The massage cushion assembly of claim 1, wherein the massage unit comprises a first massage unit and a second massage unit positioned on opposite sides of the body supporting portion.

10. The massage cushion assembly of claim 1, wherein the body supporting portion is comprised of a flexible foam.

11. The massage cushion assembly of claim 10, wherein the flexible foam is comprised of a visco-elastic foam.

12. The massage cushion assembly of claim 1, further comprising a comfort layer positioned atop the body supporting portion, the comfort layer being comprised of a visco-elastic foam.

13. The massage cushion assembly of claim 13, wherein the comfort layer has a density less than that of the body supporting portion.

14. The massage cushion assembly of claim 1, further comprising a protective layer positioned between the second surface of the body supporting portion and the base portion, such that the head portion of each of the massage members contacts the protective layer when the massage member is in the raised position.

15. The massage cushion assembly of claim 1, further comprising a foundation positioned below the base portion and configured to provide support to the base portion and the body supporting portion.

16. The massage cushion assembly of claim 15, wherein the massage unit is secured to the foundation such that the one or more massage members move relative to the foundation.

17. The massage cushion assembly of claim 15, wherein the foundation is adjustable.

18. The massage cushion assembly of claim 1, further comprising a controller operably connected to the massage unit for controlling the one or more massage members.

19. A massage cushion assembly, comprising:
a body supporting portion having a first surface and a second surface opposite the first surface;
a base portion defining one or more slots extending longitudinally through the base portion; and
a first massage unit and a second massage unit positioned on opposite sides of the body supporting portion, the first massage unit and the second massage unit each having one or more massage members,
wherein each of the one or more massage members is movable along a length of a particular slot and between a raised position and a lowered position, and
wherein each of the one or more massage members is positioned in a particular slot such that a head portion of the massage member extends out of the slot and presses against the second surface of the body supporting portion when the massage member is in the raised position.

20. A massage bed assembly, comprising:
a mattress including a body supporting layer comprised of a visco-elastic foam and having a first surface and a second surface opposite the first surface, a base portion defining one or more slots extending longitudinally through the base portion, and a protective layer positioned between the second surface of the body supporting portion and the base portion;
a first massage unit and a second massage unit positioned on opposite sides of the body supporting portion, the first massage unit and the second massage unit each having one or more massage members,
wherein each of the one or more massage members is movable along a length of a particular slot and between a raised position and a lowered position, and
wherein each of the one or more massage members is positioned in a particular slot such that a head portion of the massage member extends out of the slots, contacts the protective layer, and presses against the second surface of the body supporting portion when the massage members are in the raised position.
